(19) United States
(12) Patent Application Publication
(10) Pub. No.: US 2003/0063214 A1
(43) Pub. Date: Apr. 3, 2003

(54) Device for enlarged display of text or images on an external screen

(75) Inventor: Lukas Wilhelmus Van Hees, Prinses Mariannelaan (NL)

Correspondence Address: Ladas & Parry, 26 West 61 Street, New York, NY, 10023, US

(73) Assignee: TIEMAN HOLDING B.V.

(21) Appl. No.: 10/247,775

(22) Filed: Sep. 19, 2002

(30) Foreign Application Priority Data
Sep. 28, 2001 (NL) 1019057

(51) Int. Cl. H04N 9/47

(52) U.S. Cl. 348/373; 348/62

(57) ABSTRACT

Device for enlarged display of text or images present on an object (3), onto an external screen (20). The device comprises: a housing (2) that can be put on an object; a mirror (6) mounted within the housing (2), a camera (7) of the CCD type following the mirror, comprising firstly a focussing member (8) in the form of a sliding part being movable according to a line (10) extending almost parallel to the bottom plane (4) of the housing and being rotable simultaneously with the sliding movement, and secondly a camera housing (9) coupled to said focussing member (8) by means of threading, which housing can not be rotated but can only be moved in the direction of the axis, in which the signals of the camera (7) are transmitted, possibly through a computer, to a display (20).

The invention relates to a device for enlarged display of text or images present on an object, onto an external screen, said device comprising a mirror which can be brought above the object.

Such a device is used at lectures, for example, in order to project an image onto a screen for the audience. This device is relatively voluminous and suitable for displaying an A4-format sheet in its entirety.

This known device is less suitable for use by a person having limited eyesight, who is not or hardly capable of reading the usual, relatively small, print of a daily or a like publication.

The object of the invention is to provide a device of limited volume that can be operated easily and to that end provides for, that the device comprises: a housing that can easily be enclosed by a hand in order to be put on an object, the bottom plane of the housing being provided with an aperture for observing at least part of the object; a mirror mounted within the housing enclosing an angle of almost 45° with the bottom plane of the housing; a camera of the CCD type following the mirror, comprising firstly a focussing member in the form of a sliding part being movable according to a line extending almost parallel to the bottom plane of the housing and being rotated simultaneously with the sliding movement, and secondly a camera housing coupled to said focussing member by means of threading, which housing can not be rotated but can only be moved in the direction of the axis, in which the signals of the camera are transmitted, possibly through a computer, to a display.

Thus, a display present with a computer can be used for enlarged display of a part of a daily or a like object.

Due to the fact that both parts of the camera are coupled to one another by screw-thread and one part will rotate on movement, when sliding the two parts, they will be spaced-apart at a larger or smaller distance.

The sliding and simultaneously rotating movement of the focussing member can be effected in that said focussing member is provided with a laterally projecting pin being located in a slot provided in a guiding member for supporting the camera housing, being situated outside said focussing member, said pen at the same time being received in a sliding block mounted on a rotatably supported threaded rod.

When the focussing member is slid by means of the sliding block, the pen connected to it will be moved through said slot in the guiding member. The slot will have a curved shape, in such a way, that on sliding the focussing member, it will start to rotate immediately. The camera housing will be moved simulataneously, but can not rotate, so that both parts will be engaged or be released from one another.

By choosing the appropriate form of the slot, it can be provided for, that one always achieves an optimum focus of the image shown on the display, and this independent from the distance of the housing to the object.

In particular, the housing of the device will be in the form of a mouses, as it is applied with a computer.

Therefore, when rotating the threaded rod by means of a motor, the switches present at such a mouse can be used for rotating the threaded rod in both directions.

Obviously, an externally mounted button can serve for rotating the threaded rod, but in general, using a motor is easier.

The invention is further explained by way of an embodiment, illustrated in the drawing, in which:

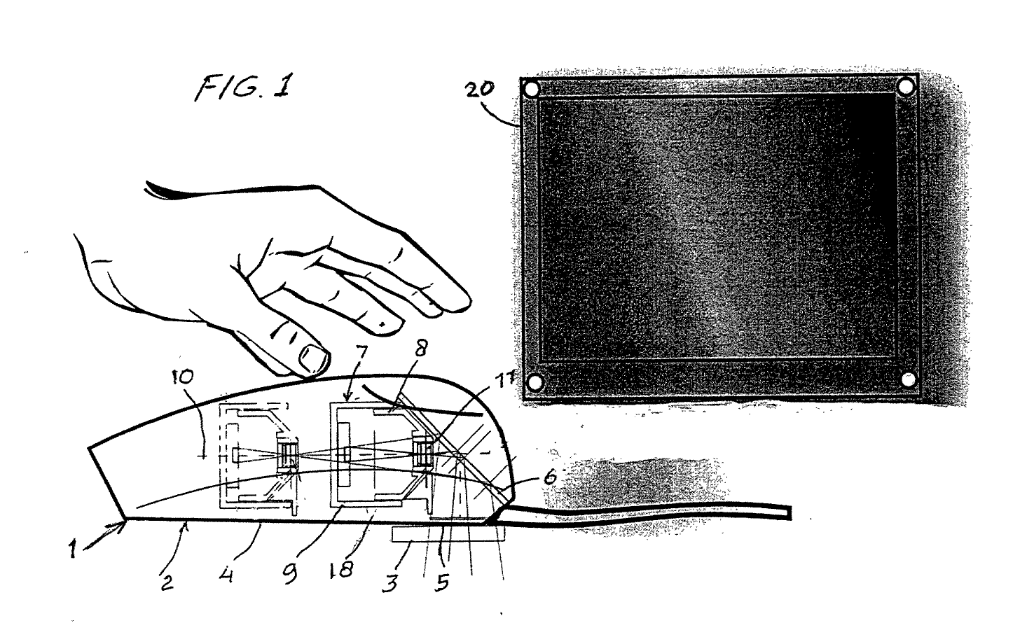

FIG. 1 shows schematically a cross-section across a device according to the invention on which an image can be displayed in an enlarged state;

FIG. 2 shows schematically a cross-section according to FIG. 1, but with further indication of the members for moving the various parts; and

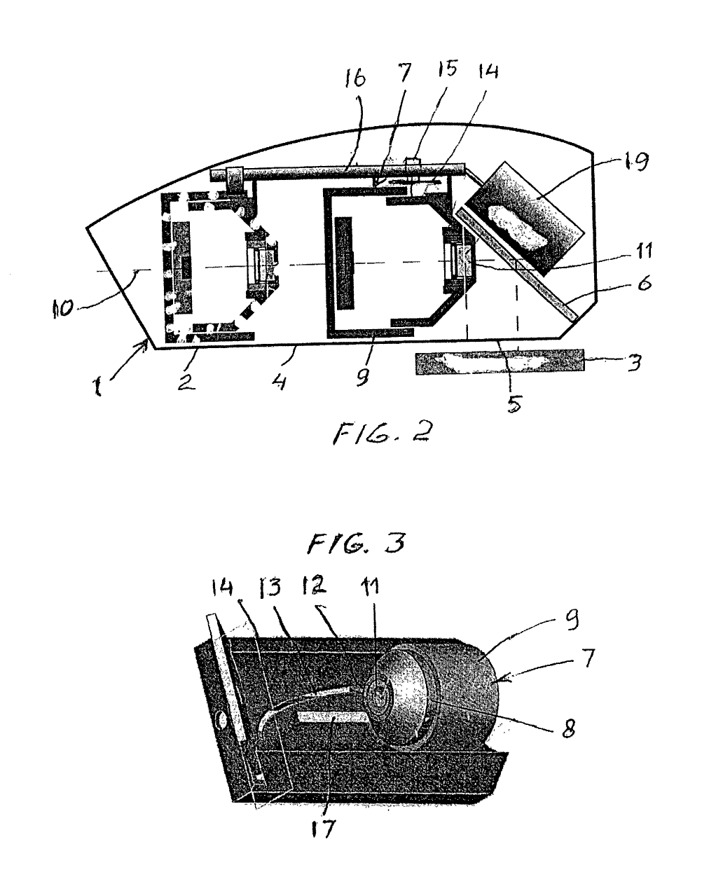

FIG. 3 shows a perspective view of a part of the guide and of the camera.

The FIGS. 1 and 2 show the device, in which housing 2 is in the form of a computer mouse. Housing 2 is located above an object 3. For observing the object 3, an aperture 5 is provided in the bottom plane 4 of housing 2.

Situated withing housing 2 is the mirror 6 followed by the camera 7 comprising a focussing member 8 and a camera housing 9. The focussing member 8 is movable according to a line 10 extending almost parallel to the bottom plane 4 of housing 2. The lens 11 is located in the sliding part 8. In FIGS. 1 and 2, the camera 7 is illustrated in two extreme positions, the first position being indicated in dashed lines.

As appears in particular from FIG. 3, focussing member 8 is provided with a pin 12 extending through a slot 13 in the guiding member 14. Pin 12 extends further in a slot, not further indicated, in a sliding block 15, which is slidable on a threaded rod 16. By rotation of the threaded rod 16, the sliding block 15 will be moved along it, since it can not rotate in relation to the threaded rod. The pin 12 will therefore perform a forced movement through the slot 13 and cause a slide and thereby a simultaneous rotation of focussing member 8. Latter rotation will cause the camera housing 9 to slide in relation to said focussing member 8. This appears in particular from FIG. 2.

The guiding member 14 is further provided with a slot 17 into which a protruding part 18, see FIG. 1, of camera housing 19 projects, so that it can only perform a rectilinear movement and is not capable of rotation.

The threaded rod 16 can be driven by means of the motor 19, which can be activated by means of switches not further indicated, which are operated by buttons situated on the housing 2.

The signals of the camera 7 are transmitted to a display 20 through a computer. A stepless enlargement can be obtained with the help of the device.

Although the use of said device by visually impaired persons is discussed hereinabove, obviously the device can also be applied for many other purposes. This will need no further explanation for an expert.

Further, it will be clear, that only one possible embodiment of a device according to the invention has been illustrated in the drawing and described above and that many changes can be made without being beyond the inventive idea, as it is indicated in the claims.

1. Device for enlarged display of text or images present on an object (3), onto an external screen (20), said device comprising a mirror (6) which can be brought above the object, characterized in that the device comprises:
a housing (2) that can easily be enclosed by a hand in order to be put on an object (3), the bottom plane (4) of the housing being provided with an aperture (5) for observing at least part of the object; a mirror (6) mounted within the housing (2) enclosing an angle of almost 45° with the bottom plane (4) of the housing; a camera (7) of the CCD type following the mirror (6), comprising firstly a focussing member (8) in the form of a sliding part being movable according to a line (10) extending almost parallel to the bottom plane (4) of the housing and being rotated simultaneously with the sliding movement, and secondly a camera housing (9) coupled to said focussing member (8) by means of threading, which housing can not be rotated but can only be moved in the direction of the axis, in which the signals of the camera (7) are transmitted to a display (20).

2. Device according to claim 1, characterized in that the sliding and simultaneously rotating movement of the focussing member (8) is effected in that said focussing member is provided with a laterally projecting pin (12) being located in a slot (13) provided in a guiding member (14) for supporting the camera housing (9), being situated outside said focussing member (8), said pen at the same time being received in a sliding block (15) mounted on a rotatably supported threaded rod (16).

3. Device according to claim 1 or 2, characterized in that the threaded rod (16) is rotatable by means of a motor (19), in which the motor can be acuated by the switches present on the housing (12).
